(19) United States
(12) Patent Application Publication
(10) Pub. No.: US 2026/0318350 A1
(43) Pub. Date: Oct. 15, 2026

(54) DRIVESHAFT FOR TRANSMITTING A DRIVE TORQUE OF A MOTOR VEHICLE

(71) Applicant: Dr. Ing. h.c. F. Porsche Aktiengesellschaft, Stuttgart (DE)

(72) Inventors: Rüdiger Bardelang, Bad Rappenau (DE); Thomas Zink, Schömberg (DE)

(73) Assignee: Dr. Ing. h.c. F. Porsche Aktiengesellschaft, Stuttgart (DE)

(21) Appl. No.: 19/646,712

(22) Filed: Apr. 14, 2026

(30) Foreign Application Priority Data
Apr. 15, 2025 (DE) 102025114678.0

(51) Int. Cl. F16C 1/24; F16C 1/04

(52) U.S. Cl. CPC F16C 1/24; F16C 1/04

(57) ABSTRACT

An articulated shaft for transmitting a drive torque of a motor vehicle to at least one drive wheel is provided. The articulated shaft includes a connecting shaft for torque-transmitting coupling of a transmission to the drive wheel, a transmission-side inner tilt joint for tiltable and torque-transmitting coupling of the connecting shaft to the transmission, a wheel-side outer tilt joint for tiltable and torque-transmitting coupling of the connecting shaft to the drive wheel, and a cooling channel passing through the connecting shaft for fluidly connecting the inner tilt joint to the outer tilt joint for a cooling fluid. The cooling channel formed within the torque-transmitting connecting shaft can be used to cool and lubricate the tilt joints in a space-saving manner without significantly adversely affecting the mechanical properties of the connecting shaft, so that a space-saving articulated shaft with low wear is enabled.

### CROSS-REFERENCE TO RELATED APPLICATION

This application claims priority to German Patent Application No. 10 2025 114 678.0, filed Apr. 15, 2025, the content of such application being incorporated by reference herein in its entirety.

### FIELD OF THE INVENTION

The invention relates to an articulated shaft, by means of which a drive torque of a motor vehicle can be transmitted to drive wheels of the motor vehicle, and to a motor vehicle with such an articulated shaft.

### BACKGROUND OF THE INVENTION

DE 102 30 768 A1, which is incorporated by reference herein, shows an axle shaft running from a differential of a motor vehicle to wheel hubs of drive wheels, which is provided with a conveying screw on one half in order to convey a lubricant for cooling purposes between the axle shaft and a pipe surrounding the axle shaft to a planetary gear train provided in the respective wheel hub, wherein the lubricant is conveyed in a circle through the interior of the axle shaft. There is a need in a motor vehicle to reduce wear in a space-saving manner and to provide measures that enable a space-saving articulated shaft with low wear.

### SUMMARY OF THE INVENTION

An aspect of the invention relates to an articulated shaft for transmitting a drive torque of a motor vehicle to at least one drive wheel, with a connecting shaft for torque-transmitting coupling of a transmission to the drive wheel, a transmission-side inner tilt joint for tiltable and torque-transmitting coupling of the connecting shaft to the transmission, a wheel-side outer tilt joint for tiltable and torque-transmitting coupling of the connecting shaft to the drive wheel, and a cooling channel passing through the connecting shaft for fluidly connecting the inner tilt joint to the outer tilt joint for a cooling fluid.

It has been found that, unlike a rigid and non-tiltable connection of a drive shaft, tilting the connecting shaft of the articulated shaft during compression of the motor vehicle and/or the drive wheel creates friction in the tilt joints, which can lead to increased wear of the tilt joints. This wear may be avoided or reduced by cooling and/or lubricating the tilt joints with the aid of a cooling fluid, which may in particular also be a lubricant, for example lubricating oil. In addition, it has been found that when the connecting shaft is tilted during regular operation of the articulated shaft, the inner tilt joint and the outer tilt joint are simultaneously, and generally substantially equally, stressed, so that it may be advantageous to fluidly connect both the inner tilt joint and the outer tilt joint to one another via a common cooling channel. As a result, the supplied cooling fluid can be fed to both tilt joints in succession or in parallel and preferably discharged again via a common outlet and/or fed to a radiator or heat exchanger for cooling purposes in order to be able to reuse the cooling fluid in a closed loop.

The axial distance between the transmission-side inner tilt joint and the wheel-side outer tilt joint is bridged by the cooling channel. However, for this purpose the cooling channel is not formed outside the connecting shaft with the aid of a pipe sealing the connecting shaft radially outward, but instead extends inside the connecting shaft through the connecting shaft, which is hollow in this respect. The cooling channel is thereby formed radially within a material cross section of the connecting shaft used for torque transmission. Compared to a solid shaft with a comparably large amount of material, the connecting shaft can thereby have a higher area moment of inertia in a cross section transverse to the torque flow, so that the connecting shaft can transmit a particularly high torque relative to its mass. Particularly in electrically driven motor vehicles, in which the full drive torque is already available at start-up, this ensures an operationally reliable and low-wear drive of the electrically driven motor vehicle. By concentrating the material of the connecting shaft at a larger radius, the connecting shaft forms a cavity radially on the inside, in particular one that is continuous in the axial direction, which can be used in a space-saving manner to form the cooling channel. In particular, the cavity may be large enough that the cooling channel can guide the cooling fluid through the connecting shaft both in a first axial direction leading from the transmission to the drive wheel and in a second axial direction leading from the drive wheel to the transmission. The cooling channel formed within the torque-transmitting connecting shaft can be used to cool and lubricate the tilt joints in a space-saving manner without significantly adversely affecting the mechanical properties of the connecting shaft, so that a space-saving articulated shaft with low wear is enabled.

The articulated shaft may comprise a transmission-side inner housing part in which the connecting shaft is tiltably received via the inner tilt joint. The inner housing part may, in particular, be connected to an output shaft of a differential gear or integrally form the output shaft of the differential gear. It is also possible for the articulated shaft to comprise a wheel-side outer housing part in which the connecting shaft is tiltably received via the outer tilt joint. The outer housing part is, in particular, part of a wheel hub of the drive wheel. The articulated shaft may tilt relative to a wheel axle of the drive wheel, in particular extending horizontally, and/or a drive axle, which is in particular defined by a connected differential gear, by a flexion angle within an X-Y plane, so that an offset in a vertical Z-direction can be bridged by the tilted connecting shaft.

The connecting shaft is configured to transmit a defined predetermined maximum drive torque, such that the area moment of inertia of the material of the connecting shaft is configured to transmit the torque occurring in this case without significant plastic deformation. The connecting shaft is in particular made of steel.

The drive wheel may include a wheel hub to which the connecting shaft can engage in a torque-transmitting manner via the outer tilt joint. The drive wheel may roll on a surface in order to drive the motor vehicle with the aid of the torque applied at a given rotational speed.

The inner tilt joint and/or the outer tilt joint may allow the connecting shaft to tilt, but torque transmission, in particular in a positive locking manner, is maintained over the entire flexion angle of the connecting shaft. The respective tilt joint may, for example, be configured as an arc toothing arrangement. The respective tilt joint may preferably comprise a coupling element, for example a ball or a cone, which is fixed in the radial direction on an inner ring and an outer ring. The coupling element may roll or slide correspondingly on the inner ring and the outer ring during a tilting movement, and may abut, in the tangential direction, against stops coupled to the inner ring and to the outer ring, respectively, in order to be able to transmit the applied torque in different tilt positions of the respective tilt joint.

The cooling channel may, in particular, be partially bounded by the material of the connecting shaft. The cooling channel may continue outside of the connecting shaft, in particular in the area of the tilt joints.

The cooling fluid may be a liquid and/or gaseous medium that can absorb heat generated by friction in the tilt joints. The cooling fluid can, in particular, simultaneously lubricate the tilt joints and, in this respect, have tribological properties to form a friction-reducing lubricating film. The cooling fluid is, in particular, a lubricating oil. The heat absorbed by the cooling fluid may preferably be dissipated via the outside of the connecting shaft by natural or forced convection. In particular, the cooling fluid may be cooled within a closed-loop circuit in a radiator or heat exchanger, for example a front radiator cooled by the airstream.

In particular, it is provided that the connecting shaft is configured as a hollow shaft and a conveying pipe is provided within the connecting shaft for conducting the cooling fluid, wherein, in particular via the outer tilt joint, a fluid connection is formed between an annular space formed between an outer side of the conveying pipe and an inner side of the connecting shaft and an interior of the conveying pipe for the cooling channel. By means of the conveying pipe, the hollow interior of the connecting shaft may be divided into two flow cross-sections separated from one another by the conveying pipe, which can be flowed through by the cooling fluid in different axial directions of the connecting shaft. Outside the conveying pipe, the cooling fluid may flow in the annular space in the one axial direction, while within the conveying pipe, the cooling fluid may flow in the opposite axial direction. As a result, it is possible within the connecting shaft to provide both a flow of the cooling fluid toward the outer tilt joint and a flow back away from the outer tilt joint. In contrast to the connecting shaft, the conveying pipe does not need to transmit any drive torque and can therefore be substantially unloaded during normal operation of the articulated shaft. The conveying pipe can therefore be designed for comparatively low loads and can have a correspondingly small wall thickness. For example, the conveying pipe is made of thin sheet metal or plastic, in particular thermoplastic. The conveying pipe may be of rigid design, although it is also possible to form the conveying pipe as a flexible hose.

Preferably, at least one conveying helix is provided in the annular space for conveying the cooling fluid along the cooling channel. The conveying helix may be motion-coupled to the connecting shaft and may rotate with the connecting shaft. As a result, the conveying helix can move cooling fluid entering a helical free space of the conveying helix with a motion component in the axial direction along the cooling channel, so that a conveying pressure can build up in the cooling channel. In particular, the mass flow rate and/or the conveying pressure may increase as the rotational speed of the articulated shaft and thus the connecting shaft increases, so that particularly good cooling and/or lubrication can be achieved at high vehicle speeds.

Particularly preferably, in a common axial region of the conveying helix, the connecting shaft comprises a supply opening for supplying the cooling fluid into the annular space and/or a discharge opening for removing the cooling fluid from the annular space, wherein the discharge opening is in particular part of a spray nozzle for spraying the inner tilt joint and/or the outer tilt joint. The supply opening and/or the discharge opening may form a through-opening penetrating the wall of the connecting shaft, so that the cooling channel may run within the connecting shaft. If the discharge opening, as part of the spray nozzle, sprays the associated tilt joint, preferably the at least one coupling element of the associated tilt joint, improved cooling and/or lubrication may be achieved.

In particular, at least one nozzle body is provided, in the axial direction outside the connecting shaft, for forming a spray nozzle for spraying the inner tilt joint and/or the outer tilt joint. The nozzle body is configured separately from the connecting shaft and can in particular also be configured separately from the conveying pipe. For example, the nozzle body is attached outside the connecting shaft to the conveying pipe in order to enable a supply and/or removal of cooling fluid to and/or from the interior of the conveying pipe. In this case, the nozzle body can cause cooling fluid coming from the conveying pipe or another source to be sprayed via the spray nozzle, due to the applied conveying pressure, onto the associated tilt joint, in particular the coupling element.

It is preferably provided that the nozzle body is in fluid communication with the conveying pipe upstream of the spray nozzle. The cooling fluid can thereby be sprayed from the conveying pipe via the nozzle body onto the associated tilt joint, in particular the outer tilt joint, preferably after the cooling fluid has already cooled the inner tilt joint upstream.

Additionally or alternatively, the nozzle body and/or another nozzle body divides the cooling channel into a first sub-channel and a second sub-channel, wherein the first sub-channel is provided for exclusively cooling the inner tilt joint and the second sub-channel is provided for exclusively cooling the outer tilt joint. The nozzle body may branch off a portion of the mass flow of the cooling fluid, in particular in order to cool and/or lubricate the inner tilt joint, while another partial flow of the cooling fluid, preferably via the conveying pipe, is directed to the outer tilt joint for cooling and/or lubricating. The two partial flows from the two sub-channels can, in particular, be recombined in a portion of the annular space, wherein preferably a common conveying helix combines the two partial flows from the two sub-channels and discharges them again as a common overall flow.

It is in particular preferably provided that the inner tilt joint and the outer tilt joint are configured to accommodate a flex angle α of the connecting shaft relative to a horizontal of 1°≤α≤20°, in particular 2°≤α≤15°, and preferably 5°≤α≤10°. The tilt joints may permit a correspondingly strong tilting of an outer ring relative to an inner ring, in particular via an intermediate coupling element. Driving comfort can thereby be improved, wherein the cooling and/or lubrication performance of the cooling fluid supplied via the cooling channel is sufficient to avoid, or at least reduce, unnecessary wear at such flex angles.

A further aspect relates to a motor vehicle having a powertrain for transmitting a, in particular electrically generated, drive torque to a left drive wheel and a right drive wheel, wherein the powertrain includes a coupling unit, in particular configured as a differential gear, for driving the left drive wheel via a tiltable left articulated shaft and for driving the right drive wheel via a tiltable right articulated shaft, wherein the left articulated shaft and/or the right articulated shaft is configured as the articulated shaft, which may be designed and further developed as described above. The cooling channel formed within the torque-transmitting connecting shaft can be used to cool and lubricate the tilt joints in a space-saving manner without significantly adversely affecting the mechanical properties of the connecting shaft, so that a space-saving articulated shaft with low wear is enabled.

In particular, the coupling unit comprises a supply line for supplying the cooling fluid into the cooling channel and/or a drain line for discharging the cooling fluid from the cooling channel. The cooling fluid can, in particular, also be used for cooling and/or lubricating a differential gear. In addition, it is possible that both the left and the right articulated shaft can be supplied with cooling fluid via only one supply line and one discharge line in the coupling unit.

### BRIEF DESCRIPTION OF THE DRAWINGS

The invention will now be described using preferred example embodiments with reference to the accompanying drawings, wherein the features described hereinafter can represent an aspect of the invention both individually and in combination, wherein the scope of protection is determined by the claims. The figures show:

FIG. 1: a schematic cross-sectional view of a first embodiment of an articulated shaft,

FIG. 2: a schematic detail view of an inner end of the articulated shaft of FIG. 1,

FIG. 3: a schematic detail view of an outer end of the articulated shaft of FIG. 1,

FIG. 4: a schematic cross-sectional view of a second embodiment of an articulated shaft,

FIG. 5: a schematic detail view of an inner end of the articulated shaft of FIG. 4, and

FIG. 6: a schematic detail view of an outer end of the articulated shaft of FIG. 4.

### DETAILED DESCRIPTION OF THE INVENTION

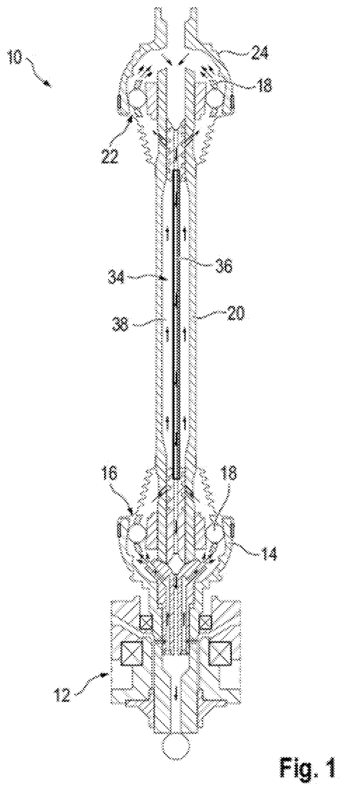

The articulated shaft 10 shown in FIG. 1 can be used in a motor vehicle, in particular an electrically driven one, to transmit drive power transmitted by a powertrain to at least one drive wheel. For this purpose, the powertrain of the motor vehicle can have a coupling unit 12 in order to drive the articulated shaft 10. The coupling unit 12 is, for example, a differential gear, to whose respective output shafts the articulated shaft 10 can be coupled. The articulated shaft 10 has an inner housing part 14 into which the drive power can be introduced. Via an inner tilt joint 16, which has coupling elements 18 in the form of balls, the applied torque can be transmitted in a positive-locking manner from the inner housing part 14 to a connecting shaft 20. The connecting shaft 20, in turn, can transmit the torque in a positive-locking manner to an outer housing part 24, which can be connected to a wheel hub of the drive wheel or forms the wheel hub integrally, via an outer tilt joint 22, which likewise has coupling elements 18 configured as balls.

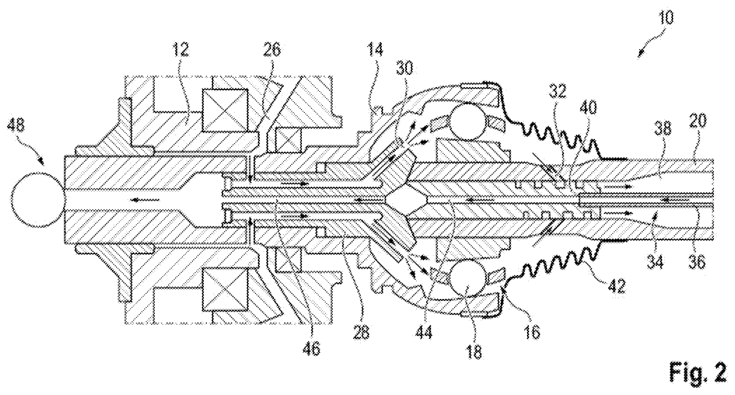

As shown in FIG. 2, a cooling fluid can be supplied via an inlet line 26 in the coupling unit 12, which, in the illustrated exemplary embodiment, can be introduced, in particular through the inner housing part 14, into a nozzle body 28, which can spray the cooling fluid onto the inner tilt joint 16 via a spray nozzle 30. Thereafter, the cooling fluid can enter the hollow interior of the connecting shaft 14 via a supply opening 32 in the connecting shaft 14, where a cooling channel 34 is formed. A conveying pipe 36 is provided coaxially with the connecting shaft 14, so that a portion of the cooling channel 34 is formed radially outside the conveying pipe 36 in an annular space 38 within the connecting shaft 14, and another portion of the cooling channel 34 is formed radially inside the conveying pipe 36. In the illustrated exemplary embodiment, a conveying helix 40 is also provided in the annular space in order to convey the cooling fluid toward the drive wheel via the supply opening 32. To prevent the cooling fluid coming from the inner tilt joint 16 from flowing away, a flexible bellows 42 is connected to the inner housing part 14 and the connecting shaft 20. In addition, the conveying helix 40 has a central opening 44 into which one end of the conveying pipe 36 is inserted, in order to discharge the heated cooling fluid, in particular via a central channel 46 formed in the nozzle body 28, for example via a check valve 48, in particular for cooling. The cooled cooling fluid can then be supplied again via the inlet line 26 within a closed loop.

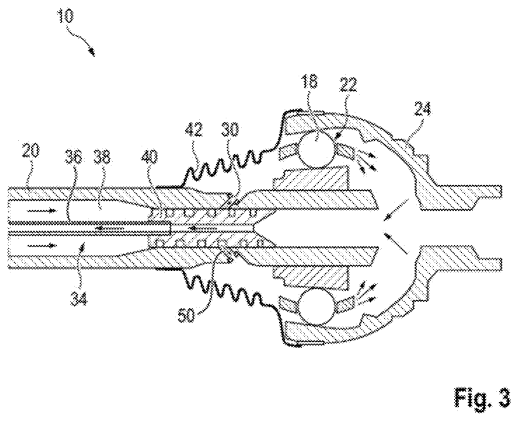

As shown in FIG. 3, the cooling fluid supplied via the annular space 38 of the cooling channel 34 can be sprayed onto the outer tilt joint 22 via a spray nozzle 30 in a discharge opening 50 in the connecting shaft 20. For this purpose, a conveying helix 40 is in turn provided, the central opening 44 of which receives the other end of the conveying pipe 36. The outer housing part 24 encloses the outer tilt joint 22 and the axial end of the connecting shaft 20, so that the cooling fluid coming from the outer tilt joint 22 is conveyed into the interior of the conveying pipe 36 and is thus discharged via the cooling channel 34 toward the coupling unit 12.

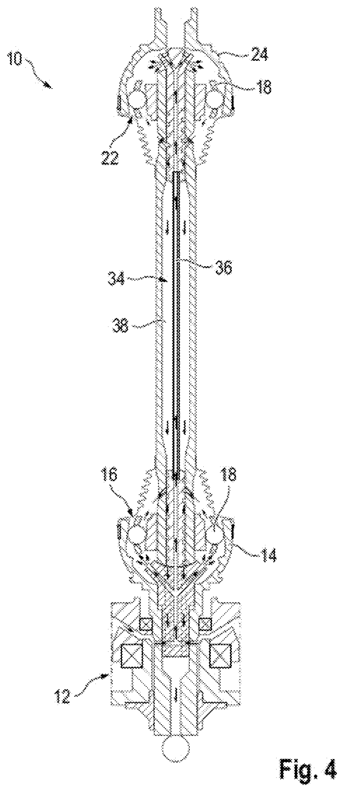

In the embodiment of the articulated shaft 10 shown in FIG. 4, the cooling fluid flows, as compared to the embodiment of the articulated shaft 10 shown in FIG. 1, radially inward in the cooling channel 34 through the conveying pipe 36 from the coupling unit 12 to the drive wheel, and radially outward in the cooling channel 34 through the annular space 38 from the drive wheel back to the coupling unit 12.

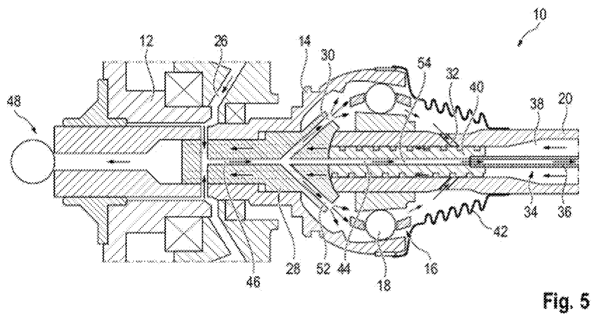

As shown in FIG. 5, only the nozzle body 28 is configured differently for this purpose. The cooling fluid not discharged via the central channel 46 of the nozzle body 28, but supplied thereto, can be divided within the nozzle body 28 into a first sub-channel 52 and a second sub-channel 54. The first sub-channel 52 can cool and lubricate the inner tilt joint 16 via the spray nozzle 30, while the second sub-channel 54 conveys the corresponding portion of the cooling fluid toward the drive wheel via the conveying pipe 36. The heated cooling fluid returning from the drive wheel in the annular space 38 can be conveyed to the coupling unit 12 by the conveying helix 40 provided radially inside the inner tilt joint 16. Here, it is possible for the cooling fluid from the first sub-channel 52, after cooling and lubricating the inner tilt joint 16, to also be supplied to the conveying helix 40 via a supply opening 32 in the connecting shaft 20, so that both partial flows of the cooling fluid are recombined in the conveying helix 40. The inner tilt joint 16 and the outer tilt joint 22 can thereby be connected in parallel, and not in series, for cooling and lubrication by the cooling fluid.

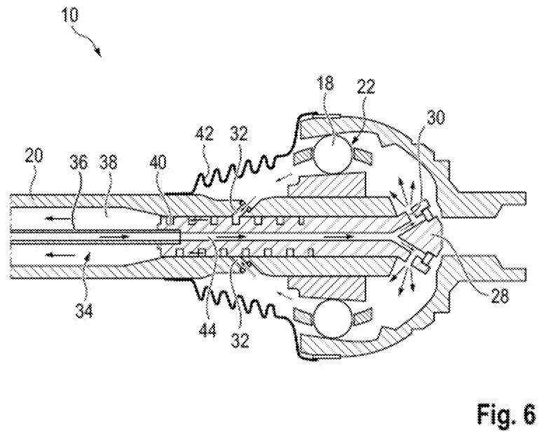

As shown in FIG. 6, a nozzle body 28 can be connected to the axial end of the conveying pipe 36, in particular at the end of a central opening 44 of the conveying helix 40 provided there, which faces away from the conveying pipe 36. The outer tilt joint 22 can be cooled and lubricated via the spray nozzles 30 of the nozzle body 28, wherein the heated cooling fluid can enter the annular space 38 of the cooling channel 34 via supply openings 32 in the connecting shaft 20 in order to be conveyed back to the coupling unit 12.

What is claimed is:

1. An articulated shaft for transmitting a drive torque of a motor vehicle to at least one drive wheel, said articulated shaft comprising:
a connecting shaft for torque-transmitting coupling of a transmission to the drive wheel,
a transmission-side inner tilt joint for tiltable and torque-transmitting coupling of the connecting shaft to the transmission,
a wheel-side outer tilt joint for tiltable and torque-transmitting coupling of the connecting shaft to the drive wheel, and
a cooling channel passing through the connecting shaft for fluidly connecting the inner tilt joint to the outer tilt joint with a cooling fluid.

2. The articulated shaft according to claim 1 further comprising a conveying pipe disposed within a hollow space of the connecting shaft for conducting the cooling fluid, wherein a fluid connection is formed between an annular space formed between an outer side of the conveying pipe and an inner side of the connecting shaft and an interior of the conveying pipe for the cooling channel.

3. The articulated shaft according to claim 2, further comprising at least one conveying helix disposed in the annular space for conveying the cooling fluid along the cooling channel.

4. The articulated shaft according to claim 3, wherein the connecting shaft, in a common axial region of the conveying helix, includes a supply opening for supplying the cooling fluid into the annular space and/or a discharge opening for discharging the cooling fluid from the annular space.

5. The articulated shaft according to claim 2, further comprising at least one nozzle body oriented in an axial direction outside the connecting shaft, the nozzle body forming a spray nozzle for spraying the inner tilt joint and/or the outer tilt joint.

6. The articulated shaft according to claim 5, wherein the nozzle body fluidly communicates with the conveying pipe upstream of the spray nozzle.

7. The articulated shaft according to claim 5, wherein the nozzle body divides the cooling channel into a first sub-channel and a second sub-channel, wherein the first sub-channel is configured for exclusively cooling the inner tilt joint and the second sub-channel is configured for exclusively cooling the outer tilt joint.

8. The articulated shaft according to claim 1, wherein the inner tilt joint and the outer tilt joint are configured to accommodate a flex angle α of the connecting shaft relative to a horizontal axis of 1°≤α≤20°.

9. The articulated shaft according to claim 1, wherein the inner tilt joint and the outer tilt joint are configured to accommodate a flex angle α of the connecting shaft relative to a horizontal axis of 2°≤α≤15°.

10. The articulated shaft according to claim 1, wherein the inner tilt joint and the outer tilt joint are configured to accommodate a flex angle α of the connecting shaft relative to a horizontal axis of 5°≤α≤10°.

11. A motor vehicle having a powertrain for transmitting an electrically generated drive torque to a left drive wheel and a right drive wheel of the motor vehicle, wherein the powertrain includes a coupling unit, which is configured as a differential gear, for driving the left drive wheel via a tiltable left articulated shaft and for driving the right drive wheel via a tiltable right articulated shaft, wherein the left articulated shaft and/or the right articulated shaft is the articulated shaft according to claim 1.

12. A motor vehicle having a powertrain for transmitting an electrically generated drive torque to a left drive wheel and a right drive wheel of the motor vehicle, wherein the powertrain includes a coupling unit, which is configured as a differential gear, for driving the left drive wheel via a tiltable left articulated shaft and for driving the right drive wheel via a tiltable right articulated shaft, wherein the left articulated shaft and the right articulated shaft each comprise the articulated shaft according to claim 1.

13. The motor vehicle according to claim 11, wherein the coupling unit comprises a supply line for supplying the cooling fluid into the cooling channel and/or a drain line for discharging the cooling fluid from the cooling channel.
